(19) United States
(12) Patent Application Publication
(10) Pub. No.: US 2004/0181462 A1
(43) Pub. Date: Sep. 16, 2004

(54) Electronic communication service

(76) Inventors: Robert D. Bauer, Edgewater, NJ (US); Jack W. Woodzell, Edgewater, NJ (US)

Correspondence Address: Wolff & Samson PC, One Boland Drive, West Orange, NJ, 07052, US

(21) Appl. No.: 10/807,697

(22) Filed: Mar. 24, 2004

Related U.S. Application Data
(62) Division of application No. 09/715,562, filed on Nov. 17, 2000.

(51) Int. Cl. G06F 17/60

(52) U.S. Cl. 705/26

(57) ABSTRACT

An electronic communication service is provided to which a user can subscribe and receive direct online mailings from member businesses while aggregating personal mail from across several electronic mail identifiers. A user can log into the service, provide information in the form of a name, address, and other demographic information, and the system then generates a personalized account. The user can solicit online mailings from member businesses by selecting the types and sources of offers the user wishes to receive. Member businesses can generate online mailings and can target same based on user demographic information. Businesses can provide conventional postal mailing address lists, and the electronic communication service of the present invention can convert same into an electronic mail list by matching conventional postal addresses to user electronic mail addresses based upon user provided information. In processing of email between businesses and users, the system automatically translates and substitutes name and address with electronic mail identifiers such that a user's electronic mail identification is never provided to the business. Finally, SPAM is filtered from the system by comparing all mail to a SPAM database so that only mail originating from a solicited member business is delivered to subscribed users.

### BACKGROUND OF THE INVENTION

1. Field of the Invention

This invention relates generally to an electronic communication service for selectively transmitting electronic offers and electronic mail (“e-mail”) between businesses and subscribers. More specifically, the invention allows businesses to use the service to generate and distribute online mailings to a plurality of subscribed users using an e-mail list that may be generated based on subscriber demographics or based on a business' traditional postal name and address mailing list. The invention allows businesses to designate delivery of the communication via electronic means, traditional postal service means or both. Additionally, the invention relates to a system for automatically filtering and removing unwanted electronic mail to prevent undesired electronic mail (“SPAM”) and to ensure subscriber privacy.

2. Related Art

Direct mail advertising is a huge business resulting in large volumes of mail including advertisements and catalogs. It is very difficult for individuals to unsubscribe from direct mail advertising lists. Because individuals are inundated by direct mail advertising, their attention to such advertising, and the effectiveness of such advertising, is questionable. Further, the expenses incurred by direct mail advertisers for paper and postage alone are staggering.

Direct advertisers that use the Internet to market services and products often do so by sending unsolicited e-mail to a multitude of users of the Internet. Companies that engage in such bulk mailing practices have no guarantee that the information they transmit arrives at a target consumer, nor is there any indication as to how effective such transmission practices are. As a result, companies waste resources of online service providers by continually engaging in online bulk mailings, and a significant portion of users regard such mail as SPAM.

Accordingly, what is desired, but has not heretofore been provided, is an electronic communication service that allows for the direct electronic delivery from businesses to potential customers over the Internet on the basis of user demographics, or based on conventional postal address information such as a company mailing list. What is also desired is a system for preventing unsolicited electronic mailings, so that customers receive electronic direct mailings only from the businesses they choose and without having to provide those businesses their email-id.

Past efforts in this general area include the following:

Powell, U.S. Pat. No. 5,806,044, discloses a system and method for distributing coupons through a system of computer networks. The system includes a plurality of cards and a computer network with a plurality of computers. A personal computer includes hardware and software for receiving an electronic coupon from the network of computers and transmits the coupon, in binary format, to a local card-writing device which writes the coupon data onto a portable card. The customer can take the card to a store and redeem the coupons thereon at checkout.

Dedrick, U.S. Pat. No. 5,724,521, discloses a method and apparatus for providing electronic advertisements to end users in a consumer best-fit pricing manner. The invention includes an index database, a user profile database and a consumer scale matching process. The index database provides storage space for titles of electronic advertisements. The user profile database provides storage for a set of characteristics which correspond to individual end users. The consumer scale matching process is coupled to the content database and user profile database and compares the characteristics of the individual end users with a consumer scale associated with advertisement. Then, the apparatus charges a fee to the advertiser based on a comparison by the matching process. Data is collected for the personal profile database by direct input from the end user and also by monitoring the end user's activity.

Hendrick, et al., U.S. Pat. No. 6,055,510, discloses a method for performing targeted marketing over a computer network wherein data mining is conducted by the ISP. The ISP may then make a customer aware of an offer by an e-mail with a link. If the customer takes advantage of the offer, the ISP will provide the customer's identity to the advertiser.

Moraes, U.S. Pat. No. 6,014,502, discloses an electronic mail system with advertising wherein while the user creates an e-mail message, an advertising message is displayed on a portion of the screen. When the user transmits e-mail, a connection is made to a remote e-mail server system which receives the e-mail and transmits the e-mail to the addressee, but also updates the user's local message in display with a distribution schedule. As such, the invention allows for a disconnected electronic mail system to display advertisement targeted to a user while the user receives, composes, and/or manages e-mail.

Radziewicz, et al., U.S. Pat. No. 5,854,897, discloses a network communications marketing system wherein during idle time when a computer is connected to a network but data is being processed and not transmitted. The idle time is filled with a series of prerecorded announcements which provide a waiting computer user with useful information.

Kaplan, U.S. Pat. No. 5,963,916, discloses a method for allowing a user to preview music over a computer network wherein the user transmits identification data to a website to gain access to the website and then chooses, receives, and reviews the chosen product. The demographic information given by the user can be compiled for market research. The user can receive e-mail or products of interest based on the user's interaction with the website.

Zoken, U.S. Pat. No. 5,944,787, discloses an e-mail mapper for identifying a sender's U.S. postal address by detecting in the sender's e-mail address message or other posting whether the sender's name and address are available. If the information is not present, the e-mail is reviewed for identifying the geographic locale of the sender by searching other databases.

Paul, U.S. Pat. No. 6,052,709, discloses a system and method for controlling delivery of unsolicited e-mail messages which includes positioning mailboxes on a network for receiving spam e-mail, analyzing received spam e-mailing and broadcasting a signal with respect to same. A filtering system receives the alert signal, updates filtering data and filters subsequent e-mails from the spam source.

Geiger, et al., U.S. Pat. No. 6,073,142, discloses an e-mail system for releasing, deleting, returning, forwarding, or gating e-mail messages based on business rules stored in post offices.

Gabber, et al., U.S. Pat. No. 5,961,593, discloses a system and method for providing an anonymous personalized browsing proxy system in a network. The invention allows for the automatic substitution of identifiers for sites that require user identities and prevents the server sites from determining the true identity of the user. The invention creates a proxy system to solve the problem of creating alias e-mail addresses for a user for servers which require a valid e-mail address for creating an account.

Van Wyngarden, U.S. Pat. No. 6,038,597 discloses an Internet information device including a website coupled to a first user intranet point and a second user Internet point. The first user point can be used to provide multi-level managed information to the website, and the second user point can be used to provide multi-level user access to the managed information.

U.S. Pat. No. 5,848,412 to Rowland, et al., discloses a user controlled browser identification disclosing method wherein information records are established with respective access level indicators and a website can request information at an access level assigned to the website, the access level of the website is then checked, and then information is retrieved from that access level. The user can choose the access level to provide, and thereby control the disclosure of identifying information.

U.S. Pat. No. 5,794,207 to Walker, et al., relates to a reverse auction method and discloses a method and apparatus for cryptographically assisted commercial network system designed to facilitate buyer-driven conditional purchase offers. The invention allows for buyers and sellers to remain anonymous until an agreement is consummated. A buyer database maintains buyer information including name, address, credit card number, e-mail address, public/private key information, etc.

U.S. Pat. No. 5,930,479 to Hall, discloses an e-mail system. In one aspect of the invention, an e-mail message includes a channel identifier portion for verifying that the message is authorized for delivery to the recipient. In another aspect, the address includes a hierarchy of names including a lowest level name at the lowest level of the hierarchy that includes a channel identifier. In another aspect of the invention, a mail server is provided for receiving and authenticating e-mail messages. The determination of whether the message is authorized is based on a portion of the address attached to the message. According to the invention, a user has a number of channels each with a distinct e-mail address. If unwanted e-mail arrives on a valid channel, a user may turn off the channel and allow legitimate uses of the channel to use another channel. As such, a user can have a send only channel, a private channel, a permanent public channel, a temporary public channel, a commercial channel and an introductory channel. A temporary public channel will remain opened for a limited predetermined time. A mail server is interconnected with a network and a personal channel agent is interconnected between a user's machine and the mail server. The mail client in the user machine communicates with the personal channel agent in the PCA host. All incoming and outgoing messages pass through the personal channel agent.

U.S. Pat. No. 6,108,691 to Lee, et al., discloses a directory service that allows a user to receive e-mail messages from senders without requiring the user to reveal the user's e-mail address by restricting the display of the user's e-mail addresses to preserve the privacy of the user. This allows a user to restrict access to the user's e-mail address to screen unwanted solicitations. The directory service prevents services to the user when the user joins. For example, the user provides profile information to allow the user to obtain promotional information relating to the user's interests.

None of the previous efforts, either alone or in combination, disclose or teach the benefits of the electronic communication service of the present invention, nor do they teach or suggest all of the elements thereof.

### OBJECTS AND SUMMARY OF THE INVENTION

It is a primary object of this invention to provide an electronic communication service that allows for direct online mail delivery between businesses and consumers.

It is another object of the present invention to provide an electronic communication service where a user can subscribe to and create an electronic account to which online offers from businesses can be delivered or posted.

It is another object of the present invention to provide an electronic communication service where a user can subscribe to and create an electronic account to which one or a plurality of electronic mail accounts may be created or linked so that any emails and online offers at said accounts can be aggregated and managed from within the service.

It is yet another object of the present invention to provide an electronic communication service where a business can provide conventional postal address information or electronic mailing information for delivering electronic mailings.

It is even another object of the present invention to provide an electronic communication service where a user can designate the businesses from which he or she would like to receive electronic mail.

It is still another object of the present invention to provide an electronic communication service where a user can receive electronic mail originating only from the businesses that he or she designates.

It is another object of the present invention to provide an electronic communication service where a user can receive electronic mail originating from businesses they choose without providing those businesses with access or knowledge of their email-id.

It is another object of the present invention to provide an electronic communication service where a business can generate demographic information from a plurality of subscribed users.

It is even another object of the present invention to provide an electronic communication service where a business can generate a contact list or plurality of e-mail addresses from user demographic information.

It is still another object of the present invention to provide an electronic communication service where a business can generate online mailings or electronic mail using a conventional postal address mailing list.

It is an additional object of the present invention to provide an electronic communication service where a business can send electronic mail to a user's e-mail address using conventional postal address information without knowing the email address.

It is yet an additional object of the present invention to provide an electronic communication service where a business can match customers identified by conventional names or addresses in conventional name and address lists to e-mail addresses based upon information provided by subscribed users.

It is still an additional object of the present invention to provide an electronic communication service where a business can generate targeted e-mail lists from user demographic information.

It is an additional object of the present invention to provide an electronic communication service wherein communications are posted to news servers for retrieval.

It is a further object of the present invention to provide an electronic communication system which allows for electronic communications without the use of e-mail addresses.

It is still even an additional object of the present invention to provide a direct mail communication system wherein direct mail is sent electronically, or if necessary or desired by a user, by conventional post.

It is a further object of the present invention to provide an electronic communication service that screens undesired electronic mail.

It is an additional object of the present invention to prevent SPAM.

It is another object of the present invention to compile and update a SPAM database for screening SPAM.

It is an additional object of the present invention to provide an electronic communication service that maintains a record of all undesired electronic mailings and acquires greater screening capability with increased use.

An electronic communication service is provided to which a user can subscribe and receive direct online mailings from member businesses. A user can log into the service, provide information in the form of a name, address, and other demographic information, and the system then generates a personalized account. The user can solicit online mailings from member businesses by selecting the types and sources of offers the user wishes to receive. Member businesses can generate online mailings and can target same based on user demographic information. Businesses can provide conventional postal mailing address lists, and the electronic communication service of the present invention can convert same into an electronic mail list by matching conventional postal addresses to user e-mail addresses based upon user provided information. If an e-mail account for the user does not exist, the present invention can deliver offers using conventional postal mail. SPAM is filtered from the system by comparing all mail to a SPAM database so that only mail originating from a solicited member business is delivered to subscribed users either in the form of email, newsgroup postings, or email-like postings.

The electronic communication service of the present invention further allows a user to selectively post and download electronic mail and electronic offers through newsgroup servers. Electronic mail and offers can conveniently be browsed and downloaded at the user's convenience, thereby saving network usage and decreasing download time. The user can consolidate electronic mail originating from multiple sources within a single location in the present invention.

Communications, both electronic and conventional, are delivered using conventional name and conventional postal address information, instead of e-mail identifiers. The user's privacy is protected by ensuring at all times that the user's e-mail identifier is not disclosed. A user may choose to receive only solicited advertisements and may browse information relating unsolicited advertisements. Received offers and mail may be sorted by the user according to categories, which may be defined by the user or selected from pre-defined groups.

The electronic communication service of the present invention allows for remote access by businesses and users. Both businesses and users may communicate with the present system by directly subscribing to the electronic communication service, or by purchasing a remote service that subscribes the businesses and users remotely. Once businesses and users are subscribed remotely, the remote service then connects remote businesses and users to the electronic communication service so that they can communicate with other businesses and users.

### BRIEF DESCRIPTION OF THE DRAWINGS

Other important objects and features of the invention will be apparent from the following Detailed Description of the Invention taken in connection with the accompanying drawings in which:

FIG. 1 is a flow chart showing the operation of the invention.

FIG. 2 is a more detailed flow chart of the electronic business offer processing step of FIG. 1.

FIG. 3 is a more detailed flow chart of the defining information about offer type step of FIG. 2.

FIG. 4 is a more detailed flow chart of the filtration step of FIG. 1.

FIG. 5 is a more detailed flow chart of the electronic mail and electronic offer sending step of FIG. 1.

FIG. 6 is a more detailed flow chart of the sender validation step of FIG. 5.

FIG. 7 is a more detailed flow chart of the system registered user source validation step of FIG. 6.

FIG. 8 is a more detailed flow chart of the remote domain source validation step of FIG. 6.

FIG. 9 is a more detailed flow chart of the newsletter or posting source validation step of FIG. 6.

FIG. 10 is a more detailed flow chart of the unknown source validation step of FIG. 6.

FIG. 11 is a flow chart of source and SPAM probability testing routine.

FIG. 12 is a flow chart of the SPAM database update process.

FIG. 13 is a more detailed flow chart of the inbox mail delivery step of FIG. 5.

FIG. 14 is a flow chart of the name and address substitution procedure.

FIG. 15 is a more detailed flow chart of the offer validation step of FIG. 5.

FIG. 16 is a more detailed flow chart of the process offer step of FIG. 5.

FIG. 17 is a flow chart of the deliver offer to inbox process.

FIG. 18 illustrates the databases and log files of the present invention.

### DETAILED DESCRIPTION OF THE INVENTION

The present invention relates to an electronic communication service for businesses and individual users. Businesses can use the electronic communication service of the present invention to conduct direct mail advertising and to move existing direct mail publications from postal delivery to online delivery, and thereby save the money associated with postage. The invention enables a business to send direct mail over the Internet without the business having access or knowledge of the intended recipient's email id. Individual users can use the service as a primary e-mail service, or in addition to a primary e-mail service. The e-mail service of the present invention provides a user with privacy and allows a user to choose to receive only the information or advertisements chosen by the user either initially or after the user has joined the service. Importantly, the e-mail service of the present invention filters SPAM. Users can register directly with the e-mail service or can join the service remotely through an ISP. As such, a user can join the e-mail service over the Internet or through a licensed software product.

The electronic communication service of the present invention also allows a user to receive electronic mail and offers from a business that provides only the user's conventional name and postal address information. Optionally, a user may specify one or more e-mail addresses, and the present invention allows for electronic mail originating from such addresses to be gathered and sorted at a central location. Confidentiality of the e-mail addresses is maintained throughout all transactions. Importantly, the present invention enables the delivery of electronic mail, electronic offers, and conventional mail through the use of conventional postal address information.

Electronic mail and offers of the present invention may be sorted according to pre-defined categories, including, but not limited to: company name, offer type, service, type, and product type. Additionally, a user may specify his or her own category for sorting mail. In the event that an e-mail address does not exist for a user, the present invention allows for the automatic delivery of conventional mail and offers to the user. Significantly, the user has the option of viewing both solicited and unsolicited offers, and electronic mail may be selectively downloaded through the use of newsgroup services.

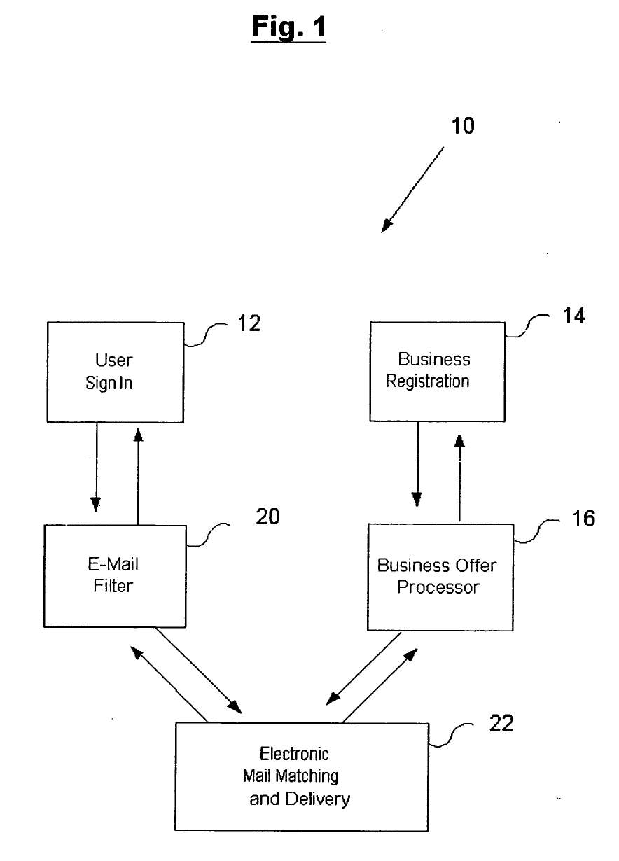

FIG. 1 is a flow chart of the electronic communication service 10 of the present invention. A user logs in and/or signs in at 12. An interface processes in step 12 consumer information provided by an individual interested in subscribing to the electronic communication service 10. Such user information processed in step 12 could include, but is not limited to, the user's name, postal address information, e-mail addresses, and preferences regarding the types of offers and information that the user wishes to receive. Step 12 further subscribes the user to the electronic communication service 10 and establishes personalized mail inboxes for receiving and aggregating personal mail plus receiving only solicited offers.

The electronic communication service 10 further comprises an interface which processes in step 14 business information provided by businesses interested in joining the electronic communication service 10. The business information could include the business address, contact information, product or service information, and mailing lists. Step 14 also subscribes the business to the electronic communication service 12 and establishes a mailing service for the business.

Once a business has subscribed to the electronic communication service 10, the electronic communication service 10 then processes in step 16 new electronic business offers established by the business. Said business offers are processed from information regarding an offer type, the products or services to which the offer pertains, where the product or service is sold or offered, any targeted recipients, selection criteria, the method of conveying the offer, and the time period for which the offer lasts. New electronic business offers are then generated via business interaction with step 16, and checked for validity. Once the offer is created and checked, step 16 then forwards the offers for further processing and storage.

The electronic communication service 10 further comprises an electronic mail filtration step 20. Said step 20 is invoked before any electronic message is sent to a user, and functions to remove any unsolicited or unwanted electronic messages from the electronic communication service 10. Step 20 achieves message filtration by comparing incoming messages against a database of known unwanted messages and senders, and if a positive comparison results, portions of the message are added to the database and marked as unwanted.

Once step 20 filters any unsolicited electronic mail, step 22 of the electronic communication service 10 then sends or posts electronic mail and offers directly to selected consumers via mail inboxes. Step 22 accomplishes this by categorizing incoming electronic mail according to sending source, validating the sending sources, and routing mail directly to the consumer's inboxes. Additionally, step 22 validates all new business offers generated by step 16, and processes said offers for delivery to said consumer's inboxes.

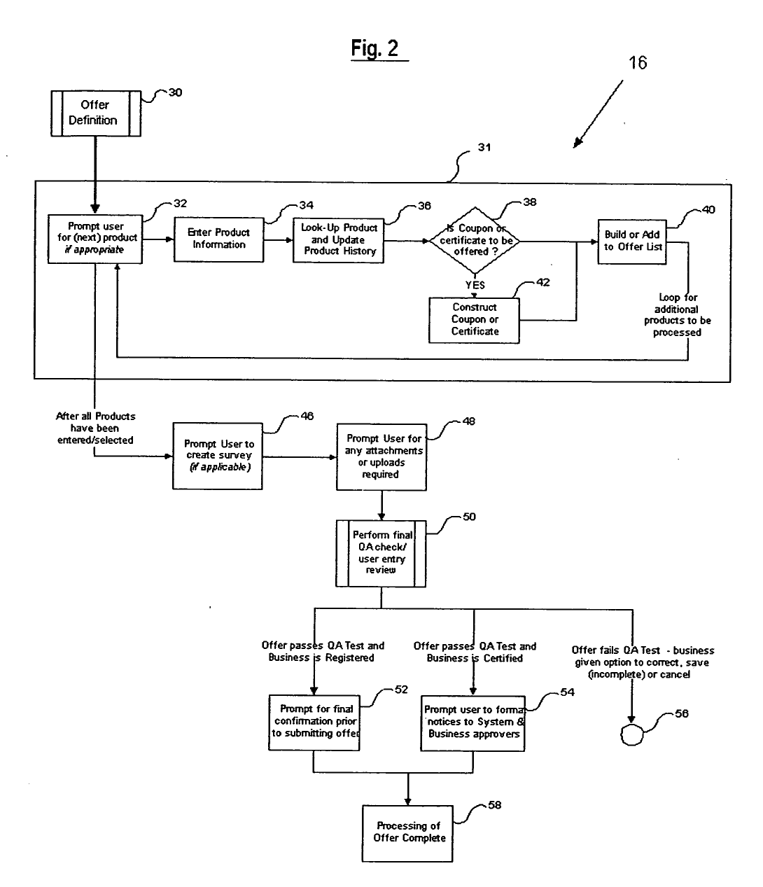

FIG. 2 depicts a more detailed flow chart of the electronic offer processing step 16 of FIG. 1. Step 16 comprises defining information regarding an offer type by a business in step 30. Once said information is defined by the business, a product description routine 31 is then invoked, whereby the business may provide information about a particular product or a series of products. The product description routine 31 prompts the user in step 32 for the next product to be described, requests and stores product information in step 34, looks up the product and updates product history in step 36, and determines if a coupon or certificate is to be offered in step 38. If a coupon is to be offered, product description routine 31 then constructs a coupon or certificate in step 42. Product description routine 31 then either builds an offer list and adds the offer to the list in step 40 if no previous offer exists, or adds the offer to the list in step 40 if a previous offer exists. Product description routine 31 then loops back to step 32 to process additional products.

If no additional products are to be processed, electronic offer processing step 16 then prompts the user in step 46 to create a survey if required. The user is then prompted in step 48 to upload any attachments or other files necessary to complete the offer. In step 50, electronic offer processing step 16 performs a final quality assurance (QA) check on all of the data entered in electronic offer processing step 16, and allows the user to review said data. If said data passes the QA check of step 50 and the business is registered user of electronic communication service 10, the user is prompted in step 52 for final confirmation. If said data passes the QA check of step 50 and the business is certified by electronic communication service 10, step 54 prompts the user to format notices. If said data fails the QA check of step 56, the user is given the option to correct said data, save said data, or exit completely from electronic offer processing step 16. At the conclusion of either steps 52 and 54, step 58 the offer as complete and electronic offer processing step 16 terminates.

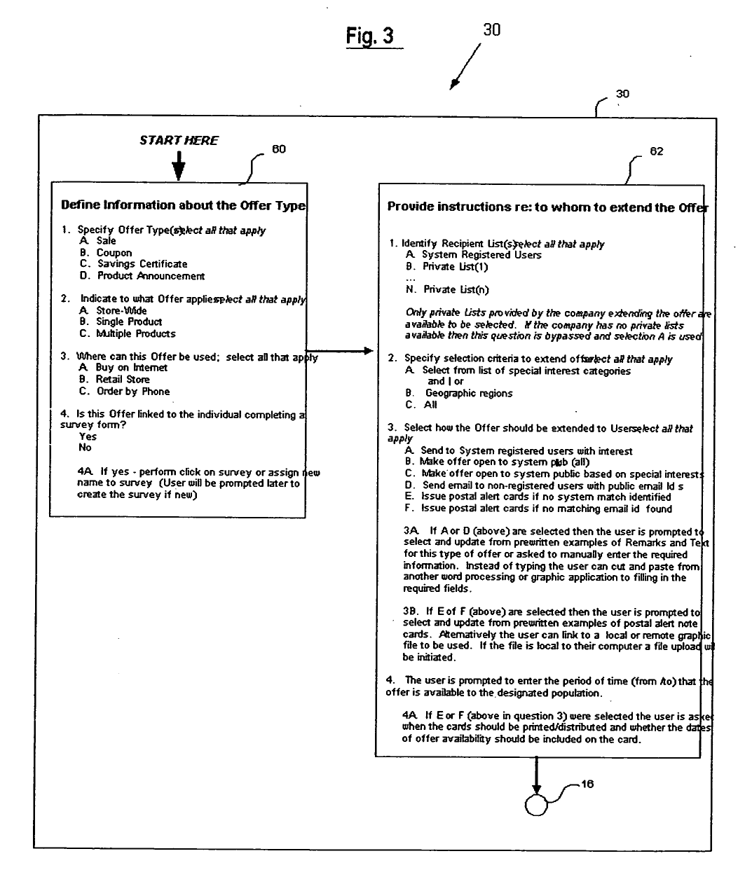

FIG. 3 is a more detailed flowchart of the offer definition step 30 of the electronic offer processing step 16 of FIG. 2. In order to effectively provide information about the offer, electronic offer processing step 16 must gather and store information from the business pertaining to the underlying products, service, and other information pertinent to the offer. This is accomplished by step 60 of the offer definition step 30, whereby the user is prompted to provide information regarding the offer (i.e., whether the offer is a sale, coupon, savings certificate, or product announcement), application of the offer (i.e., whether the offer applies store-wide, to a single product, or to multiple products), location of the offer (i.e., whether the offer can be used on the Internet, at a retail store, or for an offer by phone), and whether the offer is linked to a user completing a survey form. Additionally, offer definition step 30 gathers from the user instructions on how the offer is delivered and to whom it is extended via step 62, whereby the user is prompted to provide information regarding recipient lists (achieved by selecting from registered users or other private lists), selection criteria (achieved by selecting from special interest category lists or geographic regions, or both), method of extending offer (achieved by selecting from the options of targeting all registered users with interest, open offer to all users, open offer to all users with interest, e-mail to non-registered users with public e-mail ID's, postal alert cards where no matches are identified, or postal alert card where no matching e-mail ID's are found). In the event that the user desires to send offers to registered users with interest and to non-registered users with public e-mail ID's, step 62 prompts the user to select and update prewritten examples of remarks and text or to manually enter remarks and text. Additionally, in the event that the user decides to send postal alert cards where no users are identified or no matching e-mail ID's are found, the user is prompted to select and update prewritten examples of postal alert note cards. Alternatively, the user can link to a local or remote graphic file. Finally, step 62 prompts the user to enter a period of time for which the offer is available. If the user has decided to send postal alert cards, the user is asked to designate a location where the cards should be printed or distributed, and to designate dates of availability to be printed on the cards.

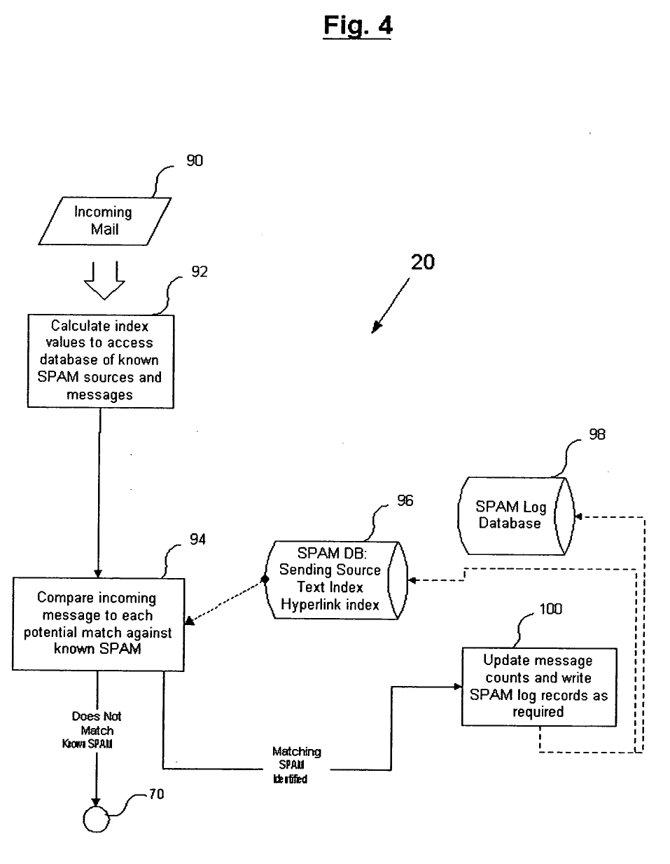

FIG. 4 depicts a more detailed flow chart of the electronic mail filtration step 20 of FIG. 1. Step 20 further comprises an incoming mail message 90, which is used by step 92 to calculate index values to access a repository of known SPAM sources and messages. Step 92 calculates index values from incoming mail message 90 by applying numeric algorithms against key parts of incoming mail message 90, including the sending source and domain, the message text, and any included hyperlinks. Once index values are generated by step 92, step 94 compares said values against a SPAM database 96 of known SPAM messages and sources. Said SPAM database 96 includes information regarding a SPAM message's sending source, a text index, a hyperlink index, a running count of exact and near matches, and a date-stamp of the most recent receipt. If a negative comparison is made by step 96, the electronic mail filtration step 20 terminates and electronic communication service 10 proceeds to sender validation step 70 of step 22. If a positive comparison is made by step 96, step 100 is invoked, whereby step 100 updates message counts and writes or updates SPAM records to SPAM database 96. Additionally, step 100 generates SPAM log records and writes same to a SPAM log database 98. Electronic mail filtration step 20 discards incoming mail message 90 if incoming mail message 90 exactly matches confirmed SPAM records. If incoming mail message 90 matches unconfirmed SPAM records, incoming mail message 90 is logged by electronic mail filtration step 20 for further review. Provided incoming mail message 90 does not match confirmed or unconfirmed SPAM records, electronic mail filtration step 20 then terminates, and electronic communication service 10 invokes sender validation step 70 of mail delivery step 22.

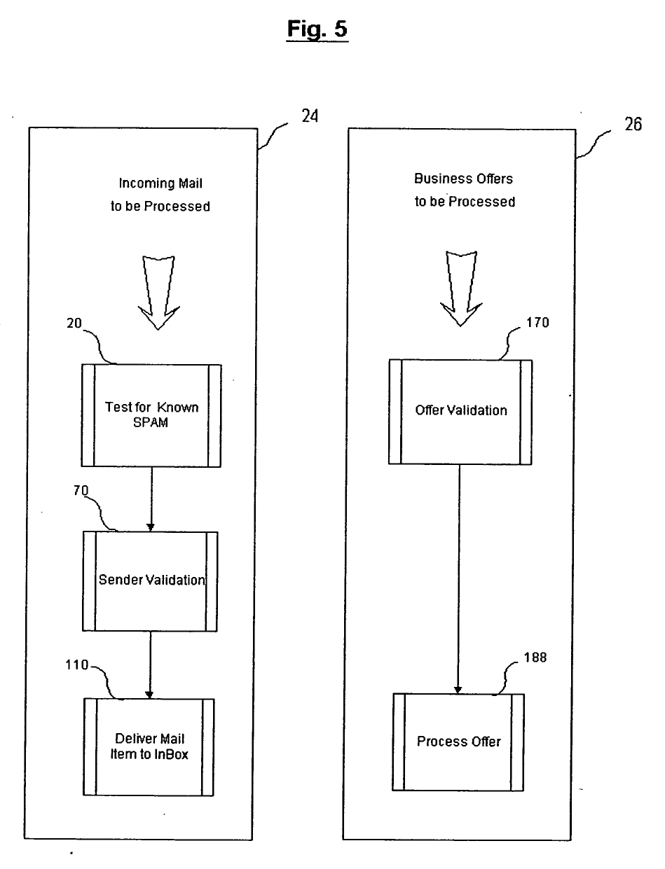

FIG. 5 depicts a more detailed flow chart of the mail delivery step 22 of FIG. 1. Step 22 allows for the delivery of electronic mail and offers amongst subscribed businesses and users. This is achieved by incoming mail delivery process 24 and business offer delivery process 26. Incoming mail delivery process 24 includes the unsolicited electronic mail filtration step 20, sender validation step 70 and inbox mail delivery step 110. An incoming electronic mail message is first filtered for unsolicited electronic mail by step 20, whereupon the message is then processed by sender validation step 70. Once sender validation step 70 processes the message, it is then delivered to subscribed users' inboxes by inbox mail delivery step 110.

The delivery of business offers is achieved by business offer delivery process 26. In process 26, a business offer, once generated, is passed to offer validation step 170, whereby the offer is checked for accuracy and verified. Once offer validation step 170 successfully validates the offer, process offer step 188 then processes the offer, whereupon the offer is ultimately delivered to subscribed users' inboxes.

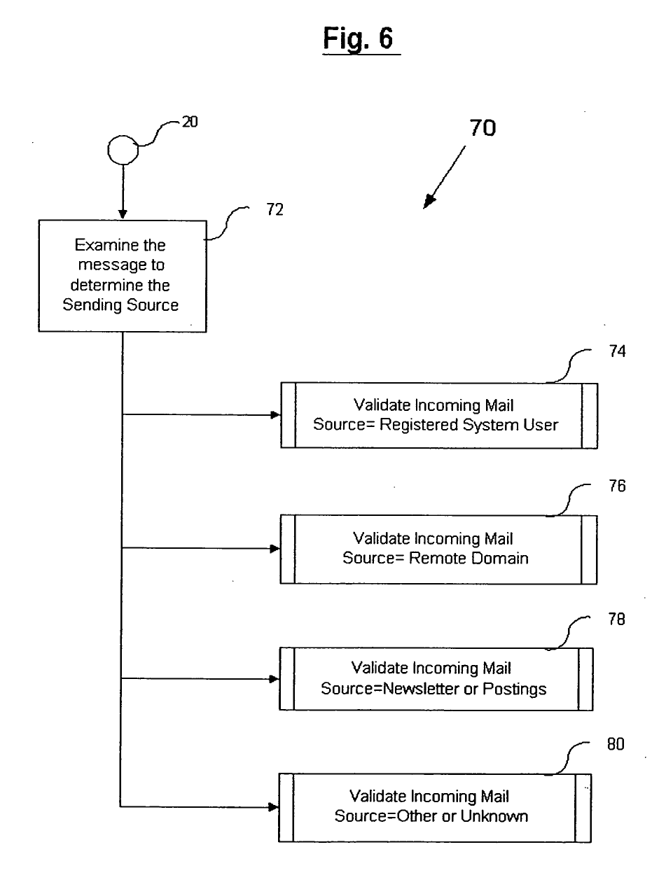

FIG. 6 depicts a more detailed flow chart of the sender validation step 70 of FIG. 5. Step 70 is configured to receive an incoming mail message that has been successfully filtered by electronic mail filtration step 20. Accordingly, by the time the message arrives at sender validation step 70, it has already been tested and filtered for undesired content or an undesired sender. Step 70 includes source examination step 72, source validation step 74 for validating direct users of the present invention, source validation step 76 for validating remote users of the present invention, posting source validation step 78, and unknown source validation step 80. In this arrangement, sender validation step 70 allows for the classification, sorting, and routing of electronic mail on the basis of its sending source. First, source examination step 72 examines the incoming electronic mail message to determine the sending source of the message. Step 72 may be achieved by, but is not limited to, the following steps: parsing the sending source domain information to determine if the message originated from a known source, determining whether the sending domain and source can be found in a database of recognized newsletter and posting sources, and flagging the message as having an unknown sending source.

Once a sending source has been determined by source examination step 72, the incoming mail message is then sent to either system source validation step 74, remote source validation step 76, posting source validation step 78, or unknown source validation step 80, depending upon the sending source determined by source examination step 72. If source examination step 72 determines that the sending source of the incoming mail message is a registered user, step 72 routes the message to system source validation step 74. If source examination step 72 determines that the sending source of the incoming mail message is a remote user, step 72 routes the message to remote source validation step 76. If source examination step 72 determines that the sending source of the incoming mail message is either a newsletter or a posting, step 72 routes the message to posting source validation step 78. If source examination step 72 determines that the sending source of the incoming mail message is unknown, step 72 routes the message to unknown source validation step 80.

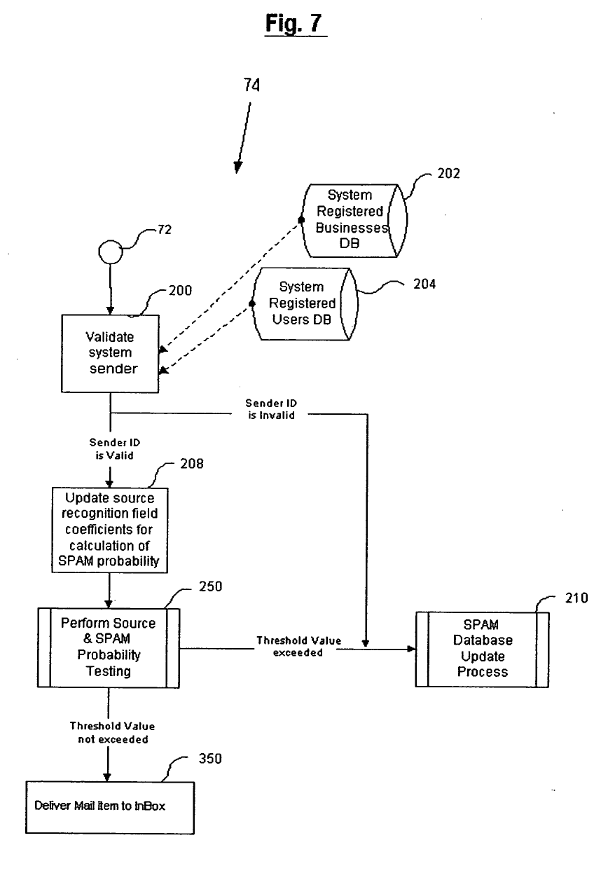

FIG. 7 is a more detailed flowchart of system source validation step 74 of FIG. 6. An incoming mail message having a sending source of a registered user is sent to system source validation step 74 by source examination step 72. Initially, system source validation step 74 processes the message in step 200, whereby the message is validated as originating from a registered system user. Step 200 validates the sending source by comparing the sending source to a registered businesses database 202 and a system registered users database 204. If step 200 determines that the sending source is invalid, step 200 sends the message to SPAM database update process 210. If the sending source is valid, the message is sent to step 208. In step 208, source recognition coefficients are updated so that a calculation of the probability that the sending source is a SPAM source may later be made. Once step 208 updates the source recognition coefficients, system source validation step 74 invokes SPAM probability testing process 250. Step 250 will then perform source and SPAM probability testing, and may result in the message being designated as SPAM if the probabilities calculated by step 250 exceed a threshold value. If a threshold value is not exceeded, the message is sent by step 250 to inbox mail delivery step 350. At this point, system source validation step 74 completes, whereupon the message is either delivered to an inbox by step 350 or treated as SPAM by step 210.

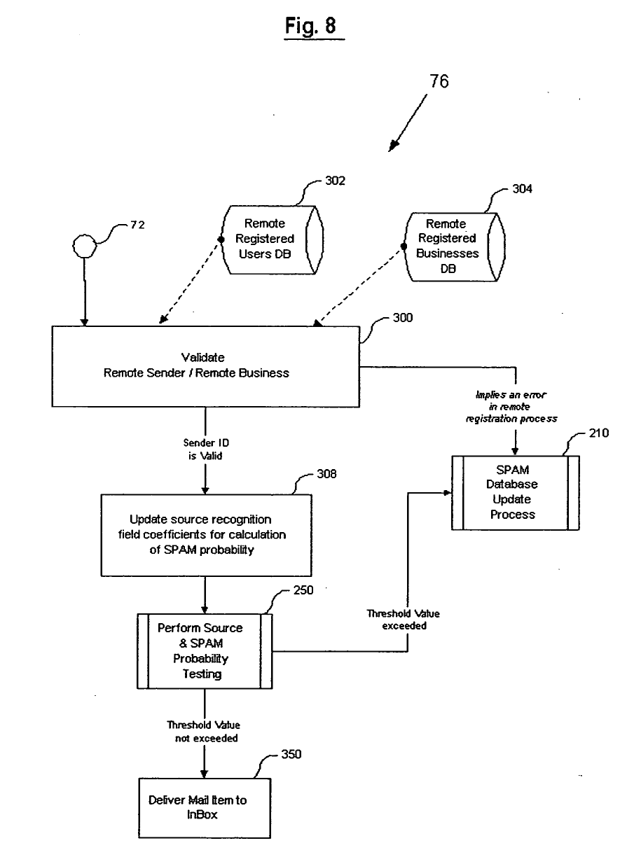

FIG. 8 is a more detailed flowchart of the remote source validation step 76 of FIG. 6. An incoming mail message having originating from a remote domain is sent to remote source validation step 76 by source examination step 72. Initially, remote source validation step 76 processes the message in step 300, whereby the message is validated as originating from a registered remote source. Step 300 validates the remote source by comparing the sending source of the message to a remote registered users database 302 and a remote registered businesses database 304. If negative comparisons are made, step 300 sends the message to SPAM database update process 210. If positive comparisons are made, step 300 sends the message to step 308, where source recognition field coefficients are updated for future SPAM testing. Once the coefficients are updated by step 308, remote source validation step 76 invokes SPAM probability testing process 250. Step 250 will then perform source and SPAM probability testing, and may result in the message being designated as SPAM if the probabilities calculated by step 250 exceed a threshold value. If a threshold value is not exceeded, the message is sent by step 250 to inbox mail delivery step 350. At this point, remote source validation step 76 completes, whereupon the message is either delivered to an inbox by step 350 or treated as SPAM by step 210.

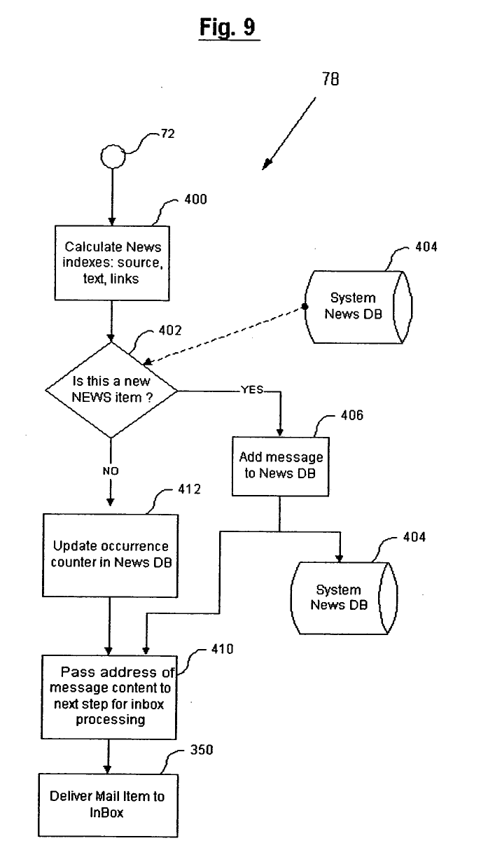

FIG. 9 is a more detailed flowchart of posting source validation step 78 of FIG. 6. An incoming mail message originating from either a newsletter or posting is sent to posting source validation step 78 by source examination step 72. Initially, posting source validation step 78 processes the message in step 400. Step 400 calculates new source indexes from the message, using the message's source designation, text, and any included hyperlinks. Once the calculations are made, step 400 invokes step 402, whereby step 402 determines whether the message is a new news item. Step 402 compares the message to a system news database 404, and determines if the message matches any existing records in the system news database 404. If a positive comparison is made by step 402, process 406 is invoked by step 402, the message is added by process 406 to the system news database 404, and step 410 is then invoked. If a negative comparison is made by step 402, process 412 is invoked by step 402, whereupon process 412 updates the occurrence counter of the system news database 404. Once the occurrence counter of the system news database 404 has been updated by step 412, posting source validation step 78 invokes step 410, whereby step 410 extracts the content of the message and passes it to inbox mail delivery step 350. At this point, posting source validation step 78 completes, and the message is delivered by inbox mail delivery step 350.

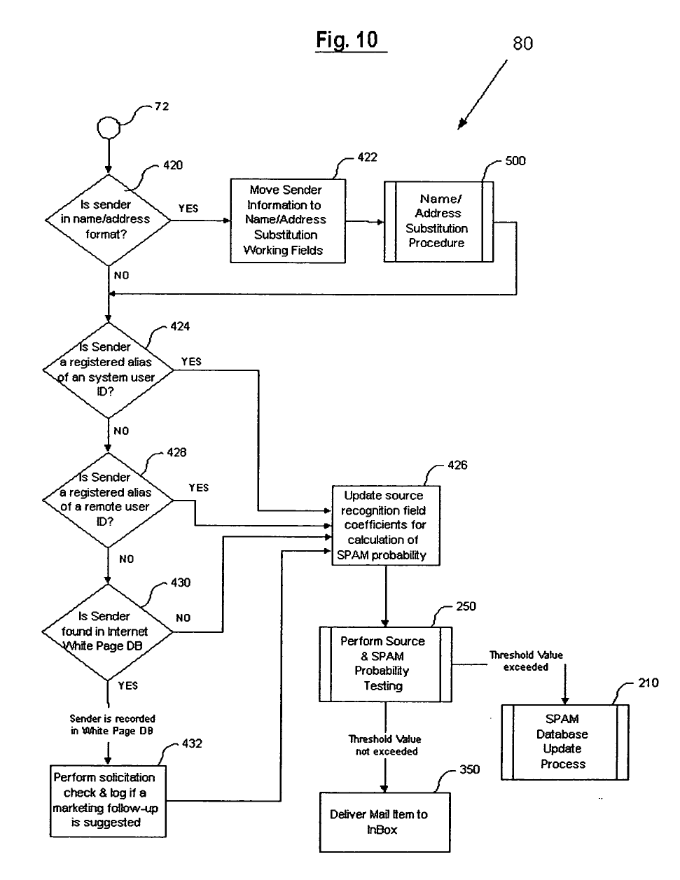

FIG. 10 is a more detailed flowchart of unknown source validation step 80 of FIG. 6. An incoming mail message originating from an unknown or unrecognized source is sent to unknown source validation step 80 by source examination step 72. Unknown source validation step 80 initially processes the message by invoking step 420. Step 420 parses the message to determine if the sender designation of the message is in name and address format. If a positive determination is made, step 420 invokes step 422 which then invokes procedure 500. In step 422, the message's sender designation is parsed and name and address substitution working fields are prepared based upon the sender designation. Upon completing the preparation, step 422 invokes process name and address substitution procedure 500. Upon the completion of procedure 500, unknown source validation step 80 then invokes step 424.

If a negative determination is made by step 420, step 424 is invoked by step 420. Step 424 parses the message to determine if the sender designation of the message is a registered alias of a system user identification. If a positive determination is made, step 424 invokes step 426. If a negative determination is made, step 424 invokes step 428, whereby step 428 parses the message to determine if the sender designation of the message is a registered alias of a remote user identification. If a positive determination is made, step 428 invokes step 426. If a negative determination is made, step 428 invokes step 430, whereby step 430 determines if the sender designation of the message exists in an Internet white pages database. If a negative determination is made, step 430 invokes step 426. If a positive determination is made, step 432 is invoked by step 430, whereby step 432 determines if a marketing follow-up is suggested, and performs a solicitation check and log. Once step 432 has finished performing the solicitation check and log, step 432 invokes step 426.

When the sender designation of the message has been checked for a match with a system registered user in step 424, a remote registered user in step 428, or an Internet white pages presence in step 430, step 426 is invoked, whereby source recognition field coefficients are updated for future calculation of SPAM probability. Once the coefficients are updated by step 426, unknown source validation step 80 invokes SPAM probability testing process 250. Step 250 will then perform source and SPAM probability testing, and may result in the message being designated as SPAM if the probabilities calculated by step 250 exceed a threshold value. If a threshold value is not exceeded, the message is sent by step 250 to inbox mail delivery step 350. At this point, unknown source validation step 80 completes, whereupon the message is either delivered to an inbox by step 350 or treated as SPAM by step 210.

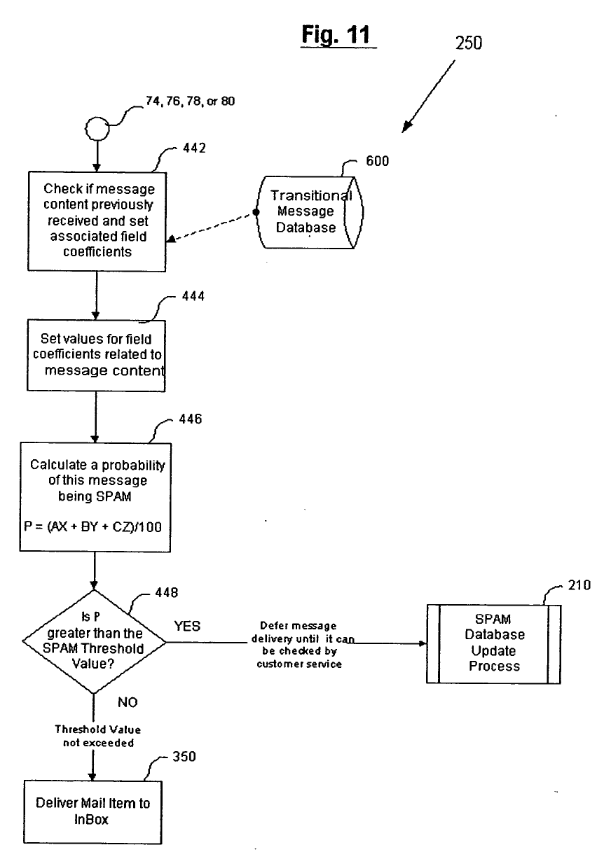

FIG. 11 is a more detailed flowchart of the SPAM probability testing process 250 of the electronic communication service 10. SPAM probability testing process 250 calculates the probability that a given message is sent from an unknown or unwanted source. Process 250 begins by invoking step 442, whereby an incoming message is checked for previous receipt by the electronic communication service 10. To determine if the message has been received in the past, step 442 calculates keys to transitional message database 600, and retrieves the number of instances where the incoming message's sending source, message text, and included hyperlinks appear in transitional message database 600. Step 442 then calculates the time interval between the incoming message and the latest instance of a matching record in transitional message database 600 using date and time stamps of both the incoming message and the matching record. Once the time interval has been calculated, step 442 assigns values to associated probability test coefficients. Step 442 then invokes step 444 and terminates.

In step 444, values for field coefficients related to message content are set, based upon the number and recognition of included hyperlinks in the incoming message, the incoming message text size, and the incoming message text and body formats, including any HTML contents. Additionally, step 444 sets field coefficients based upon metatag content of any business offers. Once the message content field coefficient values are set by step 444, step 446 is invoked, whereby the probability of the incoming message being SPAM is calculated. This calculation is performed by step 446 according to the following equation:

Probability P=(AX+BY+CZ)/100 (1)

Probability P in Equation 1 represents the probability that an incoming message is sent from an undesired or unwanted source. In Equation 1, variable X is the estimated probability of the message sending source being sent by an undesired or unwanted source, and is determined by whether the sender is recognized by the electronic communication service 10 and how long the sender is registered with the electronic communication service 10. Variable Y of Equation 1 represents the probability that the message is SPAM, and is determined by the frequency with which the incoming message content or source appears within the electronic communication service 10 in a given time period. Variable Z of Equation 1 represents the probability that the message is SPAM, and is determined by the text, included hyperlinks, and included HTML comments of the incoming message. Finally, variables A, B, and C are weighting values which can be defined and dynamically assigned by administrators of the electronic communication service 10, so that SPAM probability testing process 440 can be manipulated to achieve a desired SPAM detection rate.

Once Probability P has been determined by step 446 using the logic of Equation 1, SPAM probability testing process 250 invokes step 448, where Probability P is compared to a SPAM threshold value. The SPAM threshold value is a system parameter that can be adjusted by administrators of the electronic communication service 10 to increase or decrease the quantity of messages identified as SPAM. If step 448 determines that Probability P is greater than the SPAM threshold value, step 448 defers delivery of the message until it can be checked by customer service or an administrator of the electronic communication service 10, and then invokes SPAM database update process 210. If step 448 determines that Probability P is less than the SPAM threshold value, SPAM probability testing process 440 invokes inbox mail delivery step 350, and SPAM probability testing process 250 terminates.

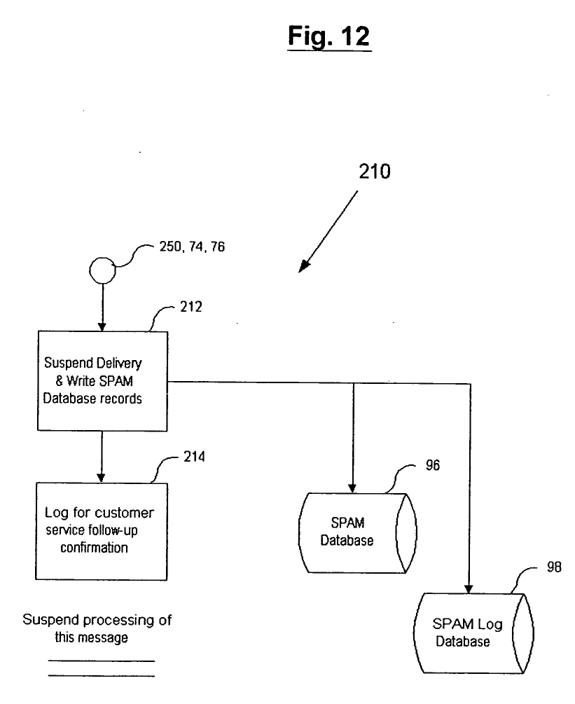

FIG. 12 represents a more detailed flowchart of SPAM database update process 210. SPAM database update process 210 is invoked by the electronic communication service 10 whenever an incoming mail message is determined to be an occurrence of SPAM. SPAM database update process 210 begins by invoking step 212, whereby delivery of an incoming message is suspended by step 212 and SPAM database records are written. While the incoming mail message delivery has been suspended, step 212 updates records in SPAM database 96 and SPAM log database 98. SPAM database 96 includes an indicator as to whether the message has been confirmed as being SPAM or is still pending review. The information written by step 212 into SPAM database 96 and SPAM log database 98 provides administrators of the electronic communication service 10 with a research trail and reason code, which will be useful to the administrators as they review the message to confirm if it contains SPAM.

When step 212 finishes updating SPAM database 96 and SPAM log database 98, step 214 is then invoked, whereby a log is generated for customer service personnel to be used in follow-up confirmation by such personnel at a later point in time. Once the log is generated by step 214, processing of the incoming message is suspended, and SPAM database update process 210 terminates.

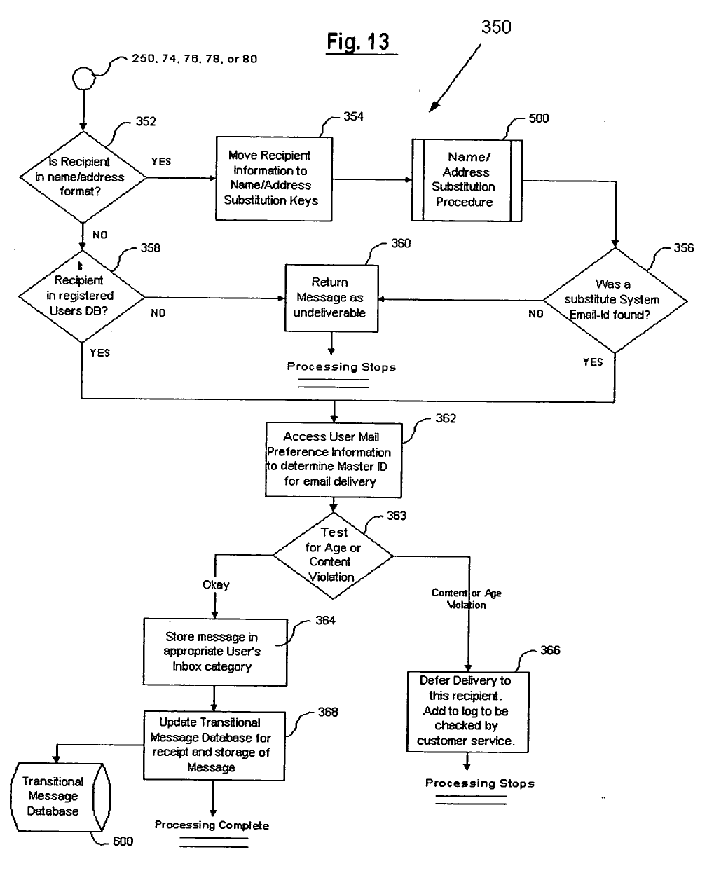

FIG. 13 is a more detailed flowchart of inbox mail delivery step 350 of the electronic communication service 10. Inbox mail delivery step 350 begins by parsing an incoming mail message in step 352 to determine if the recipient of the message is in name and address format. If a positive determination is made, step 354 is invoked, whereby the recipient information is moved to name and address substitution keys. Once the name and address substitution keys are moved by step 354, name and address substitution procedure 500 is invoked. Once procedure 500 terminates, control of inbox mail delivery step 350 is given to step 356.

If a negative determination is made by step 352 and the recipient of the incoming message is not designated in name and address format, step 352 invokes step 358, whereby the recipient information of the incoming message is checked to determine if it exists in a registered users database. If step 358 determines that the recipient does not exist in a registered users database, step 358 invokes step 360 and terminates. If step 358 determines that the recipient does exist in a registered users database, step 358 invokes step 362.

In the event that step 356 of inbox mail delivery step 350 is invoked, a comparison is performed by step 356 to determine whether a substitute system identification matches the recipient of the incoming message. If a matching system identification is found, step 356 invokes step 362. If a matching system identification is not found, step 356 invokes step 360 and terminates. Step 360 is invoked by either step 356 or step 358. When step 360 is invoked, the message is returned to the sender as undeliverable, and inbox mail delivery step 350 terminates.

In the event that either step 358 determines that the recipient of the incoming message exists in a registered users database, or step 356 determines that a substitute system identification is found, step 362 is invoked. Step 362 accesses user mail preference information to determine the master identifier for delivery of the message and to identify if adult content testing is required.

Once the master identifier is determined by step 362, step 363 checks to see if the recipient is registered as a minor with adult content filtering being designated requiring that adult content messages to be dropped prior to mail delivery. Significantly, step 363 can be supported by a third-party adult content filter service. Where the message content is appropriate for the designated recipient, step 364 is invoked.

In step 364, the incoming message is stored in the appropriate user's inbox category. Step 364 determines which inbox category to store the message based upon the message's recipient identifier, sending source, and an optional automated content parse. Upon storing the message in the appropriate inbox category, step 368 is invoked by step 364, whereby the transitional message database 600 is updated for receipt and storage of the message. Step 368 updates the transitional message database 600 so that mail messages which are received and processed within a specified time period may be recorded.

Additionally, step 368 updates the transitional message database 600 so that a count of all accumulated messages is stored, in addition to recording an audit trail of the message. The audit trail may then be used for further review by an administrator of the electronic communication service 10. Upon updating the transitional message database 600, delivery of the message is complete, and inbox mail delivery step 350 terminates.

Where the message content is appropriate for the designated recipient, step 363 invokes step 366, whereby delivery of the message is deferred and the message is logged for future checks by a customer service representative. Upon the completion of step 366, inbox mail delivery step 350 terminates.

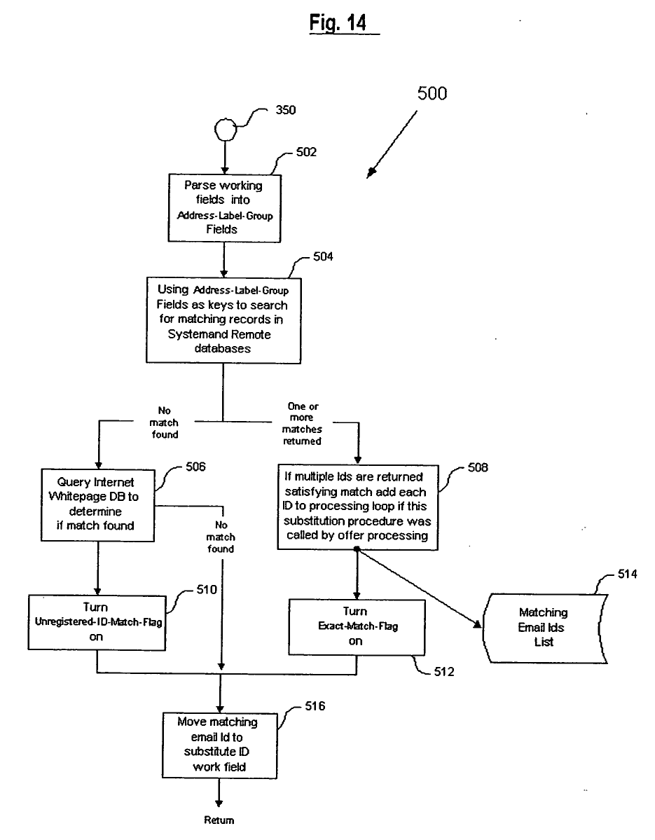

FIG. 14 is a more detailed flowchart of the name and address substitution procedure 500 of the electronic communication service 10. Procedure 500 begins by parsing the incoming message into address, label and group fields in step 502. Once the message has been parsed for address, label, and group fields, step 502 then invokes step 504, where the address, label, and group fields are used to generate keys to search for matching records in system and remote databases. Step 504 generates the keys by combining information into the following groups, including, but not limited to: (a) last name, zip code, and country, (b) last name, city, state, and country, and (c) last name and street address. Once the keys are generated from these groups, step 504 performs a search of system and remote databases to determine if records having the same keys exist. If no match is found, step 504 invokes step 506. If one or more matches are found, step 504 invokes step 508.

Step 506 is invoked if no records are found having matching key values. In step 506, an Internet whitepages database is queried to determine if matching records are found. If a match is found, step 506 invokes step 510, whereby an unregistered match flag is turned on, and control is then given to step 516.

Step 508 is invoked if one or more matching records are found in either system or remote databases. Step 508 determines whether multiple matching identifiers are returned, and if so, step 508 adds each identifier to a processing loop if name and address substitution procedure 500 was invoked by an offer process. Step 508 then stores the matching identifiers into a matching email identifiers list 514, and turns an exact match flag on in step 512. Control is then given to step 516. Step 516 then moves matching e-mail identifiers to a substitute identification work field, and name and address substitution procedure 500 terminates.

Importantly, the name and address substitution procedure 500 may be adapted to work with a variety of inputs originating from the incoming message, including, but not limited to: first name, first initial, last name, zip code, city, state, country, street address, primary e-mail identifier, alternate e-mail identifiers, and alternate e-mail configuration types.

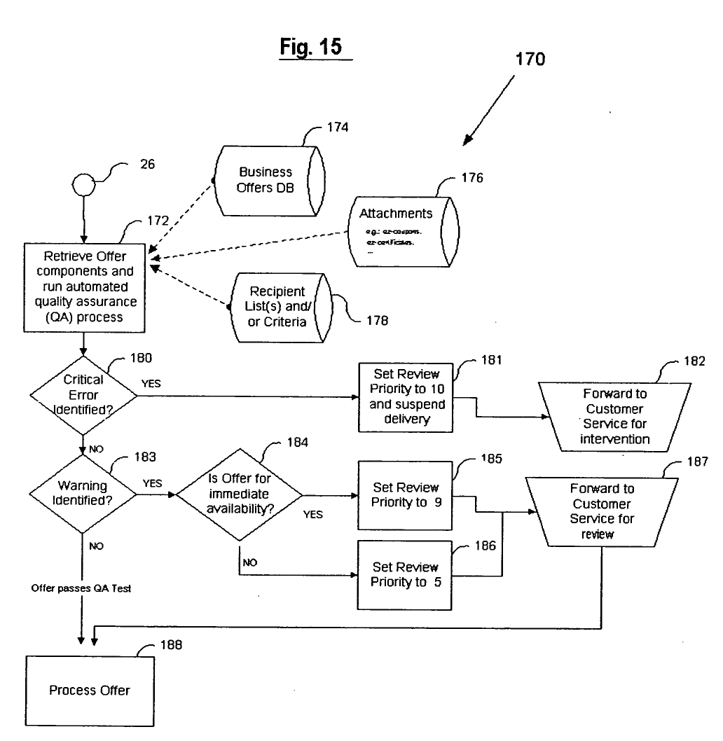

FIG. 15 is a more detailed flowchart of offer validation step 170 of FIG. 5. Offer validation step 170 begins in step 172 by retrieving offer components and running automated quality assurance (QA) processes against the offer. The offer processed by step 172 could originate from an online business offer, an offer generated by system offer services, or by a nightly batch run of offers to be posted. The information used by step 172 may also originate from a business offers database 174, an attachments database 176, and a recipient list database 178. Once the offer components have been retrieved and automated quality assurance processes applied by step 172, offer validation step 170 invokes step 180. In step 180, the offer and associated components are parsed for errors. If step 180 determines that errors exist in the offer or its associated components, step 180 invokes step 181, whereby a first priority level is set and delivery of the offer is suspended. Step 181 then invokes step 182, whereupon the offer is forwarded for customer service intervention.

In the event that step 180 determines that the offer and associated components do not contain errors, step 180 invokes step 183. In step 183, the offer and its associated components are parsed to determine if a warning has been identified. If a warning has been identified, step 183 invokes step 184. Step 184 determines if the offer is flagged for immediate availability. If step 184 determines that the offer is for immediate availability, step 184 invokes step 185, which sets a second priority level. If step 184 determines that the offer is not for immediate availability, step 184 invokes step 186, which sets a third priority level. Upon the setting of either a second or third priority level in step 185 or step 186, step 187 is invoked, whereby the offer is forwarded to customer service for review. Thereupon, step 188 is invoked, and offer validation step 170 terminates. In the event that step 183 determines that no warning has been identified for the offer, step 183 invokes step 188 so that the offer can be processed, and step 170 terminates.

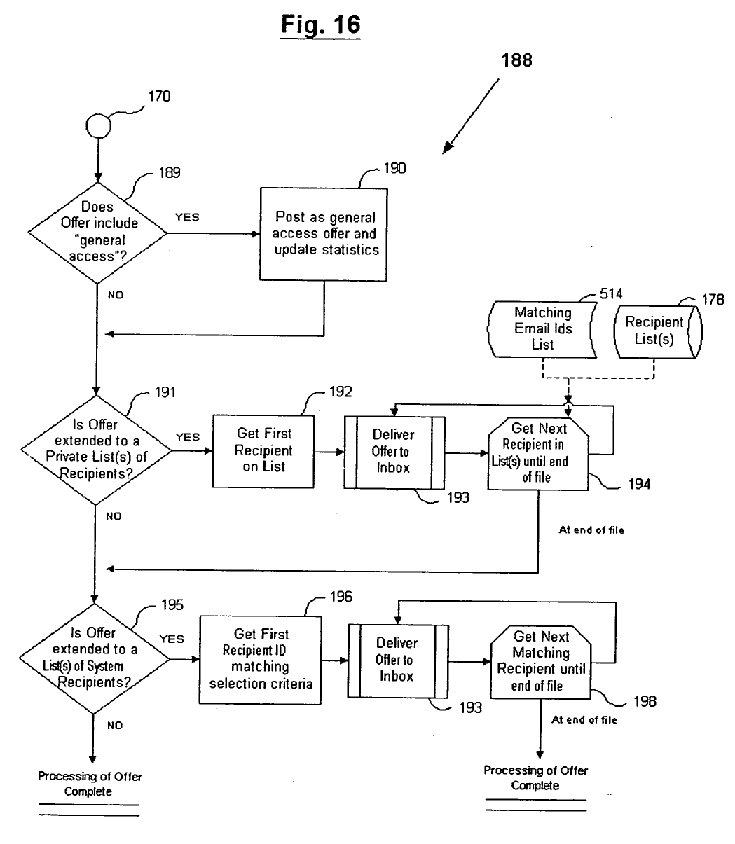

FIG. 16. Is a more detailed flowchart of the process offer step 188 of FIG. 5. Process offer step 188 begins by parsing the offer in step 189 to determine if the offer includes a general access flag. The general access flag indicates whether the offer is posted for open review and acceptance, based upon a list of criteria. Such criteria can include, but is not limited to, geography or interest information. If step 189 determines that the offer includes a general access flag, step 189 invokes step 190, whereby the offer is posted by step 190 as a general access offer and statistics are updated. When step 190 completes, step 191 is invoked.

If step 189 determines that the offer does not include a general access flag, step 189 invokes step 191. Step 191 determines if the offer is to be extended to a private list of recipients. If step 191 results in a positive determination, step 191 invokes step 192, whereby the first recipient on the list is identified. Step 192 then invokes step 193, whereby the offer is delivered to the recipient's inbox. Once delivery in step 193 is complete, step 193 invokes step 194, which retrieves the next recipient. The next recipient is retrieved first from any recipients in the matching email identifiers list 514 and then from the recipient list database 178. When the next recipient is identified, step 194 loops back to step 193, and the offer is delivered to that recipient's inbox. Step 194 continues to loop through the lists and invoke step 193 to deliver the offers, until step 194 determines that the end of the lists is reached. When the end of the list is reached, step 194 invokes step 195 and terminates.

In the event that step 191 determines that the offer is not to be extended to a private list of recipients, step 191 invokes step 195. In step 195, a determination is made as to whether the offer is to be extended to a list of system recipients. If step 195 determines that the offer is to be so extended, step 195 invokes step 196, which retrieves the first recipient having matching selection criteria. Importantly, matching is achieved in step 196 based upon preferences defined by a user of the electronic communication service 10. Once the first recipient is identified, step 196 then invokes step 193, whereby the offer is delivered to the recipient's inbox. When delivery of the offer is complete, step 193 invokes step 198, which retrieves the next matching recipient in the list. When the next recipient is identified, step 198 loops back to step 193, and the offer is delivered to that recipient's inbox. Step 198 continues to loop through the list and invoke step 193 to deliver the offers, until step 198 determines that the end of the list is reached. When the end of the list is reached, step 198 terminates, and delivery of the offers is complete. Then, process offer step 188 terminates. In the event that step 195 determines that the offer is not to be extended to a list of system recipients, step 195 terminates, and processing of offers is complete. Then, process offer step 188 terminates.

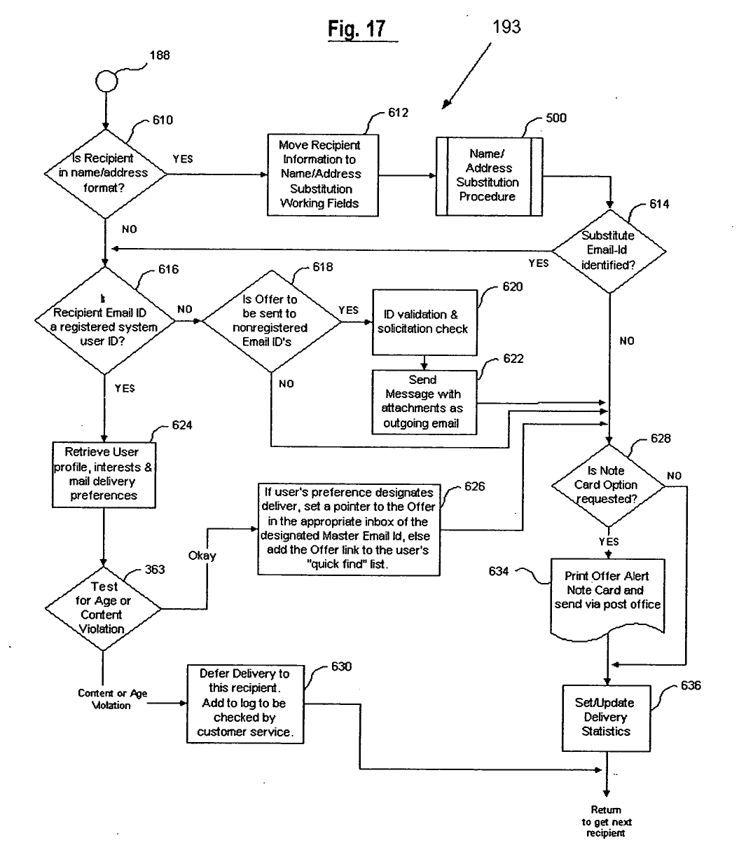

FIG. 17 is a more detailed flowchart of offer inbox delivery step 193 of FIG. 16. Delivery of an offer begins in step 610, whereby a determination is made as to whether the designated recipient of the offer is in name and address format. If step 610 determines that the offer is in name and address format, step 610 invokes step 612, whereby the recipient information is moved to name and address substitution working fields. Once step 612 has completed moving the recipient information, step 612 invokes name and address substitution procedure 500. When name and address substitution procedure 500 has completed, offer inbox delivery step 193 invokes step 614. Step 614 determines whether a substitute e-mail identifier exists. If step 614 results in a positive determination, step 616 is invoked. If step 614 results in a negative determination, step 628 is invoked.

In the event that step 610 determines that the recipient information is not in name and address format, step 610 invokes step 616. In step 616, the offer is parsed to determine if the recipient e-mail identification is a registered system user. If step 616 determines that the recipient e-mail identification is not a registered system user, step 616 then invokes step 618. In step 618, the offer is parsed to determine if it is to be sent to non-registered e-mail identifiers. If step 618 results in a positive determination, step 620 is invoked, whereby the e-mail identifier is validated and checked for solicitation status. Then, step 620 invokes step 622, whereby the message is sent with attachments as outgoing e-mail. When step 622 terminates, step 628 is invoked. In the event that step 618 determines that the offer is not to be sent to non-registered e-mail identifiers, step 618 invokes step 628.

In the event that step 616 determines that the recipient of the offer is a registered system user identifier, step 616 invokes step 624. In step 624, the user profile, interests, and mail delivery preferences are retrieved and step 363 is invoked. Step 363 checks to see if the recipient is registered as a minor with adult content filtering designated. Where the message content is inappropriate for the designated recipient, step 363 invokes step 630 which defers delivery of the offer and adds it to a log to be checked by a customer service representative. An age or adult content violation occurs if an adult content business includes a minor in any of its mailing lists. Additionally, parents of minors have the option of registering their child's identifier as a minor, to prevent receipt of adult content. Step 630 then invokes step 636 where delivery of the message is deferred and the customer service log updated. If step 363 determines that a content or age violation has not occurred, step 363 invokes step 626.

Step 626 determines whether a user's preference designates delivery of the offer. If delivery of the offer is designated, step 626 delivers the offer by setting a pointer in a designated inbox of a master e-mail identifier. Otherwise, if deliver of the offer is not designated, step 626 adds the offer to a user's quick-find list. The category under which the offer is stored in the user's inbox is determined by information gathered when the offer is created. A sequenced matching of the user's preferences to the offer categories determines the category under which the offer is stored. Businesses may be charged a lower notification fee if a user's interests match the offer categories but inbox delivery status has been deselected by the user. Once step 626 completes determination of the user and offer categories and preferences, and delivers the offer accordingly, step 626 invokes step 628 and terminates.

Step 628 determines whether the business designated a note card option when the offer was created. If step 628 determines that the business did not designate a note card option, step 628 invokes step 636. If step 628 determines that the business designated a note card option, step 628 invokes step 634. In step 634, an offer alert note card is printed and sent to the user via conventional postal mail. Once the offer alert note card is printed, step 634 invokes step 636. Step 636 sets and updates delivery statistics. When step 636 finishes updating delivery statistics, step 636 terminates. At that point, offer inbox delivery step 193 is complete and terminates.

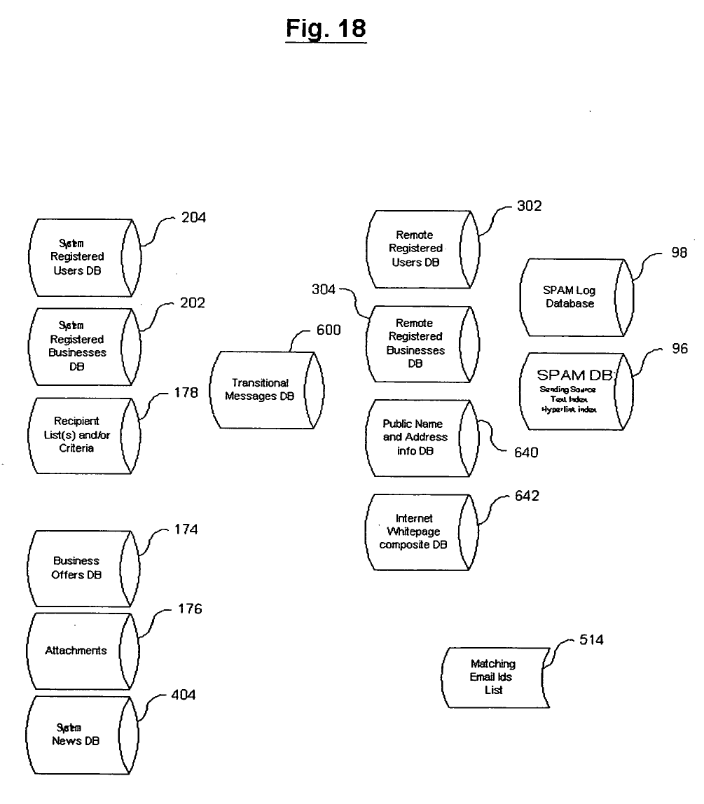

FIG. 18 is a representation of all databases and files of the present invention. The electronic communication service of the present invention includes, but is not limited to, the following databases and log files: system registered users database 204, system registered businesses database 202, recipient list database 178, business offers database 174, attachments database 176, system news database 404, transitional messages database 600, remote registered users database 302, remote registered businesses database 304, public name and address information database 640, Internet whitepage composite database 642, matching e-mail identifiers list 514, SPAM log database 98, and SPAM database 96.

Having thus described the invention in detail, it is to be understood that the foregoing description is not intended to limit the spirit and scope thereof. What is desired to be protected by Letters Patent is set forth in the appended claims.

What is claimed is:

1. An electronic communication service method comprising:
subscribing users to the electronic communication service using conventional name and conventional postal address information;
subscribing businesses to the electronic communication service;
receiving direct mail advertising materials from the businesses; and
sending the direct mail advertising materials to the users over the Internet using the conventional name and conventional postal address information.

2. The method of claim 1 wherein e-mail addresses of said users are maintained in confidence.

3. The method of claim 2 wherein said e-mail addresses are maintained in confidence during and after any transactions between users and businesses.

4. The method of claim 1 further comprising:
allowing said users to provide e-mail addresses and aliases; and
consolidating electronic mail from said e-mail addresses and said aliases at a single location.

5. The method of claim 1 further comprising using a newsgroup server to post and allow users to selectively retrieve electronic communications.

6. The method of claim 1 further comprising sorting said direct mail advertising materials according to pre-defined categories.

7. The method of claim 6 further comprising sorting said direct mail advertising materials according to user-defined categories.

8. The method of claim 1 further comprising:
obtaining demographic information from the users; and
allowing the businesses to send the direct mail advertising materials to the user based upon said demographic information.

9. The method of claim 1 further comprising allowing the users to specify types of the direct mail advertising materials which the users wish to receive.

10. The method of claim 1 further comprising allowing said users to browse offers matched and unmatched to a user's categories of interest.

11. The method of claim 1 further comprising sending conventional postal mail when a user does not have an e-mail address or prefers to receive direct mail advertising materials by conventional postal mail.

12. The method of claim 1 wherein the conventional name and the conventional postal address information is converted to e-mail addresses through a mapping function.

13. The method of claim 1 further comprising screening undesired electronic mail and undesired offers from users.

14. The method of claim 1 further comprising charging the businesses for sending the direct mail advertising materials.

15. The method of claim 14 further comprising charging the businesses for sending the direct mail advertising materials on the basis of the amount of direct mail advertising materials sent.

16. The method of claim 14 further comprising charging the businesses for sending the direct mail advertising materials on the basis of the amount of direct mail advertising materials received by the users.

17. The method of claim 14 further comprising charging the businesses for converting said conventional postal address mailing lists to e-mail addresses.

18. An electronic communication service method for a user comprising:
subscribing to the electronic communication service through a user interface using conventional name and conventional postal address information;
obtaining an account;
providing user preferences; and
receiving over the Internet mailing information offered by businesses over the electronic communication service and matched to said user preferences based upon said conventional name and said conventional postal address information.

19. The method of claim 18 further comprising:
providing demographic information; and
receiving targeted direct mail advertising materials from the businesses based upon said demographic information.

20. The method of claim 18 further comprising receiving communications screened for undesired electronic mail and undesired offers.

21. The method of claim 18 wherein correspondence is sent and received without disclosing e-mail addresses.

22. The method of claim 18 wherein said mailing information may be sorted according to categories.

23. The method of claim 18 further comprising:
providing e-mail addresses and aliases; and
consolidating electronic mail from said e-mail addresses and said aliases at a single location.

24. The method of claim 18 further comprising receiving conventional postal mail when the user does not have an e-mail address or prefers to receive direct mail advertising materials by conventional postal mail.

25. The method of claim 18 further comprising browsing offers matched and unmatched against said user preferences.

26. An electronic communication service method for a business comprising:
subscribing to the electronic communication service;
obtaining a business account;
providing direct mail advertising materials from the business to the electronic communication service;
providing conventional name and conventional postal address information from the business to the electronic communication service; and
allowing the service to send said direct mail advertising materials to a plurality of users over the Internet using said conventional name and said conventional postal address information provided by the business.

27. The method of claim 26 further comprising allowing the business to create target contact lists based upon a plurality of interested users.

28. The method of claim 26 further comprising:
obtaining demographic information from a plurality of users; and
targeting said direct mail advertising materials to said plurality of users based upon said demographic information.

29. A method of screening undesired electronic mail in an electronic communication service which comprises:
scanning an incoming mail message for an incoming sending source designation, an incoming domain designation, and an incoming text body;
generating a plurality of comparison index values from the incoming source designation, the incoming domain designation, and the incoming text body; and
identifying the incoming mail message as undesirable in response to a positive comparison between said plurality of comparison index values and known SPAM sources.

30. The method of claim 29 wherein said identification is determined by the probability that the message is from an unwanted source, the frequency with which content appears in messages in the service, the number of hyperlinks, and the targets of the hyperlinks.

31. The method of claim 29 further comprising:
logging the incoming mail message in a SPAM database;
updating a SPAM log database; and
discarding the incoming message.

32. The method of claim 30 wherein the weighing of the factors can be varied by a system administrator.

33. The method of claim 29 further comprising:
scanning an incoming mail message for an incoming hypertext link;
generating a plurality of comparison index values from the incoming hyperlink; and
comparing the plurality of comparison index values to the SPAM database.

34. A method of providing an electronic communication service at a remote location comprising:
providing software at the remote location;
subscribing users at the remote location using conventional name and conventional postal address information;
subscribing businesses to the electronic communication service;
receiving direct mail advertising materials from the businesses at the remote location;
connecting the remote location to the electronic communication service; and
sending the direct mail advertising materials to the users over the Internet using the conventional name and conventional postal address information.

35. The method of claim 34 wherein the step of subscribing businesses to the electronic communication service comprises subscribing the businesses at a remote location.

36. The method of claim 34 wherein the step of subscribing business to the electronic communication service comprises subscribing the businesses at a local location.

37. An electronic communication service apparatus comprising:
means for subscribing users to said electronic communication service apparatus using conventional name and conventional postal address information;
means for subscribing businesses to said electronic communication service apparatus;
means for receiving direct mail advertising materials from said businesses; and
means for targeting said direct mail advertising materials to said users over the Internet using said conventional name and said conventional postal address information;
wherein when said users and said businesses are subscribed to said electronic communication service apparatus, said direct mail advertising materials are retrieved from said businesses and targeted to said users.

38. The apparatus of claim 37 wherein said means for targeting preserves an e-mail account of a user in confidence.

39. The apparatus of claim 37 wherein said means for targeting preserves an e-mail account of a user in confidence after a transaction has occurred.

40. The apparatus of claim 37 further comprising means for consolidating electronic mail originating from a plurality of e-mail addresses and aliases at a single location.

41. The apparatus of claim 37 further comprising means for sorting said direct mail advertising materials according to pre-defined categories.

42. The apparatus of claim 37 wherein said means for targeting allows conventional postal mail to be sent when a user does not have an e-mail address or prefers to receive the direct mail advertising materials by conventional postal mail.

43. The apparatus of claim 37 further comprising:
means for receiving conventional postal address mailing list from the businesses; and
means for converting said postal address mailing lists to e-mail addresses.

44. The apparatus of claim 37 further comprising means for screening undesired electronic mail and undesired offers from the users.
